(19) United States
(12) Patent Application Publication
(10) Pub. No.: US 2026/0249794 A1
(43) Pub. Date: Aug. 27, 2026

(54) WIRE FIXING MEMBER AND WIRE HARNESS

(71) Applicant: Sumitomo Wiring Systems, Ltd., Yokkaichi-shi (JP)

(72) Inventor: Yuhei KOYAMA, Yokkaichi-shi (JP)

(73) Assignee: Sumitomo Wiring Systems, Ltd., Yokkaichi-shi (JP)

(21) Appl. No.: 19/548,208

(22) Filed: Feb. 24, 2026

(30) Foreign Application Priority Data
Feb. 27, 2025 (JP) 2025-030008

(51) Int. Cl. B60R 16/02; H02G 3/36

(52) U.S. Cl. CPC B60R 16/0215; H02G 3/36

(57) ABSTRACT

A wire fixing member including: a fixing portion that is configured to be fixed to a fixing target; and a wire holding portion that is configured to hold a wire, the wire holding portion including: a lock integrally formed with the fixing portion; and a band extending from the lock and being configured to hold the wire by wrapping around an outer periphery of the wire, the band having a leading end thereof inserted into and locked with the lock, wherein the band includes an elastic biasing portion that is configured to generate an elastic force that presses the band holding the wire against the fixing target in a state where the fixing portion is fixed to the fixing target.

### BACKGROUND

The present disclosure relates to a wire fixing member and a wire harness.

A wire fixing member disclosed in JP H9-196236A, for example, includes a fixing portion capable of being fixed to a fixing target on a vehicle side, a band portion for holding a wire member, and a lock portion for locking the band portion. The wire member can be held on the wire fixing member by wrapping the band portion around the outer periphery of the wire member and locking the band portion with the lock portion.

### SUMMARY

Wire fixing members of the type described above have a problem in that the band portion holding the wire member tends to vibrate in association with vehicle vibrations and the like. When the band portion holding the wire member vibrates, problems may arise such as generation of abnormal noise and damage to the band portion caused by repeated contact of the band portion with the fixing target, for example.

An exemplary aspect of the disclosure provides a wire fixing member and a wire harness that are configured to suppress vibration of a band portion holding a wire member.

The wire fixing member of the present disclosure is a wire fixing member including a fixing portion configured to be fixed to a fixing target and a wire holding portion for holding a wire member, the wire holding portion including a lock portion integrally formed with the fixing portion and a band portion extending from the lock portion and being configured to hold the wire member by wrapping around an outer periphery of the wire member and by having a leading end portion thereof inserted into and locked with the lock portion, the band portion including an elastic biasing portion configured to generate an elastic force that presses the band portion holding the wire member against the fixing target in a state where the fixing portion is fixed to the fixing target.

According to the wire fixing member and the wire harness of the present disclosure, vibration of the band portion holding the wire member can be suppressed.

### BRIEF DESCRIPTION OF THE DRAWINGS

FIG. 1 is a schematic configuration diagram showing a routing path for a wire harness of an embodiment;

FIG. 2 is a schematic front view showing a state where a wire fixing member, of the wire harness of the embodiment, is attached to an underfloor panel;

FIG. 3 is a schematic front view showing the wire fixing member, of the wire harness of the embodiment, prior to the wire fixing member being attached to the underfloor panel;

FIG. 4 is a partial front view showing a portion the wire fixing member of the embodiment; and

FIG. 5 is a partial plan view showing a portion of the wire fixing member of the embodiment.

### EMBODIMENTS OF THE DISCLOSURE

### Description of Embodiments of Present Disclosure

First, embodiments of the present disclosure will be listed and described.

[1] A wire fixing member of the present disclosure is a wire fixing member including a fixing portion configured to be fixed to a fixing target and a wire holding portion for holding a wire member, the wire holding portion including a lock portion integrally formed with the fixing portion and a band portion extending from the lock portion and being configured to hold the wire member by wrapping around an outer periphery of the wire member and by having a leading end portion thereof inserted into and locked with the lock portion, the band portion including an elastic biasing portion configured to generate an elastic force that presses the band portion holding the wire member against the fixing target in a state where the fixing portion is fixed to the fixing target.

With this configuration, the band portion of the wire fixing member includes the elastic biasing portion configured to generate an elastic force that presses the band portion against the fixing target in a state where the fixing portion is fixed to the fixing target. Thus, in a state where the wire fixing member is attached to the fixing target, the band portion holding the wire member is pressed against the fixing target by the elastic force of the elastic biasing portion. Accordingly, vibration of the band portion holding the wire member can be suppressed during vehicle vibration, for example. As a result, generation of abnormal noise, damage to the band portion, or the like caused by repeated contact of the band portion with the fixing target can be suppressed.

[2] In clause [1] above, a configuration may be adopted in which the fixing portion is attached to a columnar attachment portion provided on the fixing target in an attachment direction along an axis of the columnar attachment portion, and the fixing portion and the wire holding portion are arranged side-by-side in a direction that is orthogonal to the attachment direction.

With this configuration, the fixing portion is attached to the columnar attachment portion, which is provided on the fixing target, in the attachment direction along the axis of the columnar attachment portion. The fixing portion and the wire holding portion are arranged side-by-side in the direction that is orthogonal to the attachment direction. This configuration allows the wire holding portion including the band portion to be placed closer to the fixing target, and therefore, the band portion is easily pressed against the fixing target by the elastic force of the elastic biasing portion. As a result, vibration of the band portion holding the wire member can be more suitably suppressed.

[3] In clause [2] above, the band portion may be configured such that, in a state where the band portion holds the wire member and the fixing portion is not yet attached to the columnar attachment portion, a portion of the band portion is located on a downstream side of the fixing portion in the attachment direction.

With this configuration, the band portion is configured such that, in a state where the band portion holds the wire member and the fixing portion is not yet attached to the columnar attachment portion, a portion of the band portion is located on the downstream side of the fixing portion in the attachment direction. This configuration allows the band portion to be placed closer to the fixing target, and therefore, the band portion is easily pressed against the fixing target by the elastic force of the elastic biasing portion.

[4] In any one of clauses [1] to [3] above, a configuration may be adopted in which the elastic biasing portion is provided at a base end portion of the band portion that is connected to the lock portion, and the elastic biasing portion is curved so as to be recessed toward an inner peripheral side in a state where the band portion is wrapped around the wire member.

With this configuration, the elastic biasing portion is provided at the base end portion of the band portion that is connected to the lock portion. In addition, the elastic biasing portion is curved so as to be recessed toward the inner peripheral side in a state where the band portion is wrapped around the wire member. This enables the elastic biasing portion to have a shape that facilitates pressing of the band portion against the fixing target.

[5] A wire harness of the present disclosure includes the wire fixing member according to any one of clauses [1] to [4] above and the wire member.

With this configuration, the band portion of the wire fixing member includes the elastic biasing portion configured to generate an elastic force that presses the band portion against the fixing target in a state where the band portion holds the wire member. Thus, in a state where the wire fixing member is attached to the fixing target, the band portion holding the wire member is pressed against the fixing target by the elastic force of the elastic biasing portion. Accordingly, vibration of the band portion holding the wire member can be suppressed during vehicle vibration, for example. As a result, generation of abnormal noise, damage to the band portion, or the like caused by repeated contact of the band portion with the fixing target can be suppressed.

### Details of Embodiments of Present Disclosure

Specific examples of the present disclosure will be described below with reference to the drawings. In the drawings, the configuration shown may be partially exaggerated or simplified for convenience of description. In addition, the dimensional ratios of the respective portions may differ among the drawings. The term “orthogonal” as used herein includes not only cases that are strictly orthogonal, but also cases that are substantially orthogonal, provided that the functions and effects of the embodiments of the present disclosure are achieved. Furthermore, the term “facing” as used herein refers to a state where surfaces or members are positioned facing each other, and includes not only cases where they are positioned completely facing each other but also cases where they are positioned partially facing each other. In addition, the term “facing” as used herein includes both cases where a member separate from the two parts is interposed between the two parts and cases where nothing is interposed between the two parts. The terms “first”, “second”, and the like as used herein are used solely to distinguish objects and do not imply any ranking of the objects. The present disclosure is not limited to these examples, but rather is indicated by the claims, and is intended to include all modifications that come within the meaning and scope of equivalency of the claims.

### Overall Configuration of Wire Harness 10

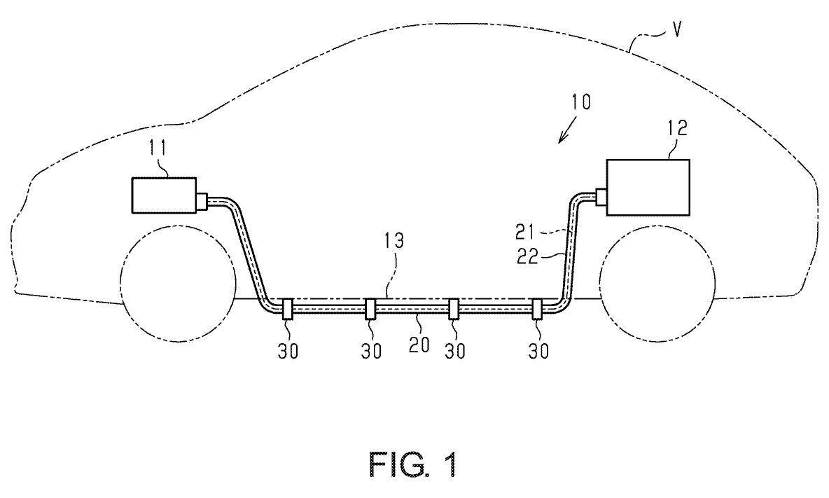

A wire harness 10 shown in FIG. 1 electrically connects two or three or more electrical devices. The wire harness 10 of an embodiment of the present disclosure electrically connects, for example, an inverter 11 installed in a front portion of a vehicle V, such as a hybrid vehicle or an electric vehicle, to a high-voltage battery 12 installed behind the inverter 11 in the vehicle V.

The inverter 11 is connected to a wheel-driving motor (not shown) that serves as a power source for vehicle propulsion. The inverter 11 generates AC power from DC power of the high-voltage battery 12 and supplies the AC power to the motor. The high-voltage battery 12 is, for example, a battery capable of supplying a voltage of several hundred volts.

The wire harness 10 is routed through regions such as under the floor of the vehicle V, for example. Specifically, for example, the wire harness 10 is routed to extend downward from the inverter 11 to below an underfloor panel 13 of the vehicle V, further extend toward a rear portion of the vehicle V through a region below the underfloor panel 13, and further extend upward to the high-voltage battery 12. It should be noted that the terms “upward” and “downward” used to describe the wire harness 10 in the present embodiment refer to upward and downward directions in a state where the wire harness 10 is fixed to the vehicle V.

The wire harness 10 includes a wire member 20 (wire) and, for example, a plurality of wire fixing members 30. Each wire fixing member 30 fixes the wire member 20 to, for example, the underfloor panel 13 serving as a fixing target within the vehicle V. It should be noted that the wire fixing members 30 are formed of a synthetic resin.

### Configuration of Wire Member 20

The wire member 20 includes one or more wires 21 and an exterior material 22, such as a corrugated tube, that covers the outer periphery of the wire(s) 21. The wire(s) 21 is connected to the inverter 11 at one end. The wire(s) 21 is connected to the high-voltage battery 12 at the other end. The wire(s) 21 is, for example, a high-voltage wire capable of accommodating high voltage and large current. The exterior material 22 forms the outer periphery of the wire member 20 and has, for example, a circular shape.

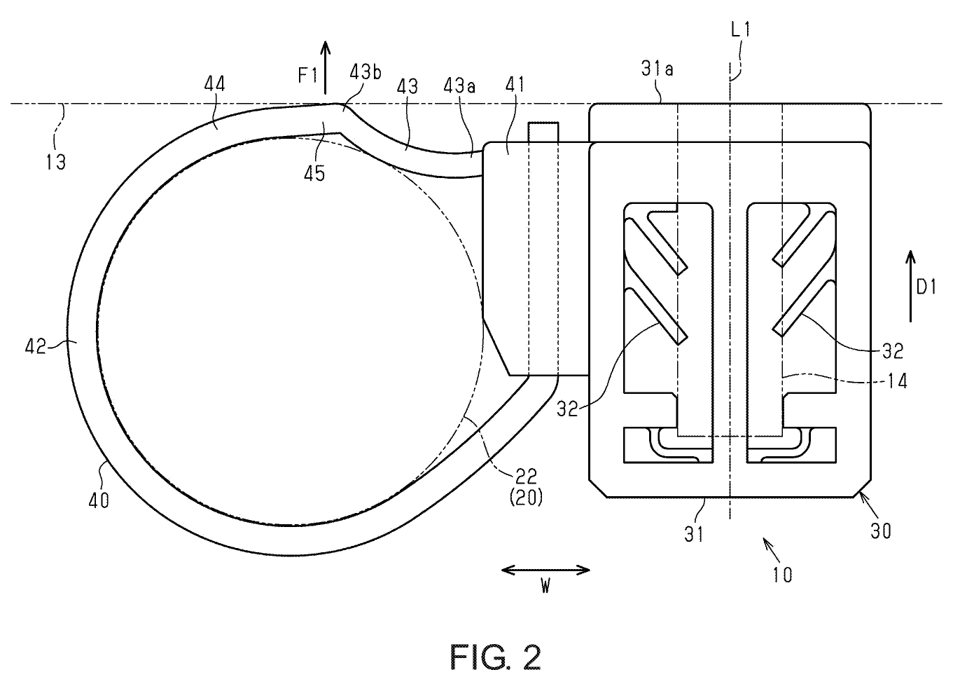

As shown in FIG. 2, the underfloor panel 13 is provided with a stud bolt 14 as a columnar attachment portion (columnar attachment). For example, the stud bolt 14 protrudes downward from the underfloor panel 13 toward the ground. The underfloor panel 13 is provided with a plurality of stud bolts 14. The plurality of wire fixing members 30 are respectively attached to the plurality of stud bolts 14.

### Configuration of Wire Fixing Member 30

Each wire fixing member 30 includes a fixing portion 31 that can be fixed to the underfloor panel 13 serving as the fixing target, and a wire holding portion 40 for holding the wire member 20. The fixing portion 31 is attached to the stud bolt 14, which is provided on the underfloor panel 13, in an attachment direction D1 along the axis L1 of the stud bolt 14. The fixing portion 31 and the wire holding portion 40 are arranged side-by-side in a width direction W that is orthogonal to the attachment direction D1. The fixing portion 31 and the wire holding portion 40 are, for example, integrally formed with each other by injection molding. It should be noted that, in the following description, for convenience of description, the attachment direction D1 is taken as the upward direction of the wire fixing member 30, and the opposite direction is taken as the downward direction; however, the wire fixing member 30 is not necessarily used in an orientation in which the attachment direction D1 (upward direction) is vertically upward.

### Configuration of Fixing Portion 31

The fixing portion 31 is configured, for example, to allow insertion of the stud bolt 14 along its axis L1. The fixing portion 31 has a plurality of engagement claws 32 that can elastically engage with a threaded groove or a circumferential groove of the inserted stud bolt 14. The plurality of engagement claws 32 of the present embodiment are provided, for example, in pairs, arranged in two tiers, one pair above the other, each pair disposed on opposite sides of the stud bolt 14 in the radial direction. Thus, the fixing portion 31 can be fixed to the stud bolt 14 and the underfloor panel 13 by the engagement claws 32 engaging with the stud bolt 14 while the stud bolt 14 is inserted in the fixing portion 31. In a state where the wire fixing member 30 is attached to the stud bolt 14, an upper end surface 31a (an end surface in the attachment direction D1) of the fixing portion 31 abuts against the underfloor panel 13 in the attachment direction D1.

### Configuration of Wire Holding Portion 40

The wire holding portion 40 includes a lock portion 41 (lock), and a band portion 42 (band) having flexibility and having a flexible band-like shape. The lock portion 41 is integrally formed on one side surface of the fixing portion 31 in the width direction W. The lock portion 41 is configured to be lockable with the band portion 42 by the band portion 42 being inserted upward from below the lock portion 41. The band portion 42 is integrally formed with the lock portion 41 so as to extend from one side surface of the lock portion 41 in the width direction W. The band portion 42 holds the wire member 20 by wrapping around the outer periphery of the exterior material 22 of the wire member 20 and by having its leading end portion inserted into and locked with the lock portion 41. The band portion 42 is configured such that, by being inserted upward into the lock portion 41 and locked with the lock portion 41, the band portion 42 is prevented from coming off from the lock portion 41 in a downward direction.

### Configuration of Elastic Biasing Portion 43

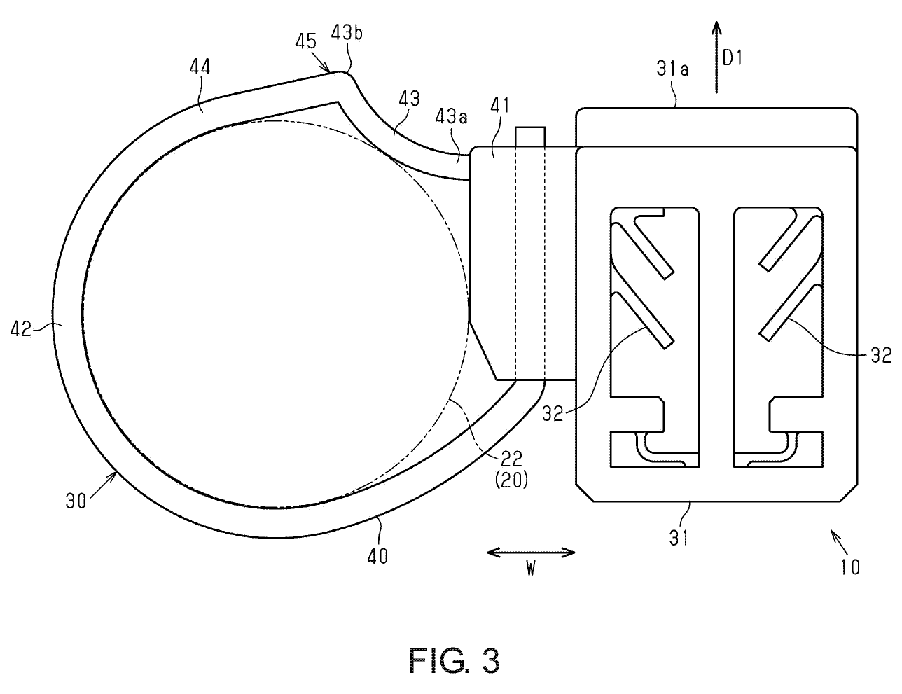

As shown in FIGS. 2 and 3, the band portion 42 includes an elastic biasing portion 43 and a band body 44. It should be noted that FIG. 3 shows the wire fixing member 30 in a state where it holds the wire member 20 and is not yet attached to the underfloor panel 13. The elastic biasing portion 43 is provided, for example, at a base end portion of the band portion 42 that is connected to the lock portion 41. The band body 44 is a portion of the band portion 42 that extends from the elastic biasing portion 43 to the leading end portion.

The elastic biasing portion 43 is curved so as to be recessed toward an inner peripheral side (the wire member 20 side) in a state where the band portion 42 is wrapped around the wire member 20. The elastic biasing portion 43 generates an elastic force F1 that presses the band portion 42 against the underfloor panel 13 in a state where it is wrapped around the wire member 20 and holds the wire member 20.

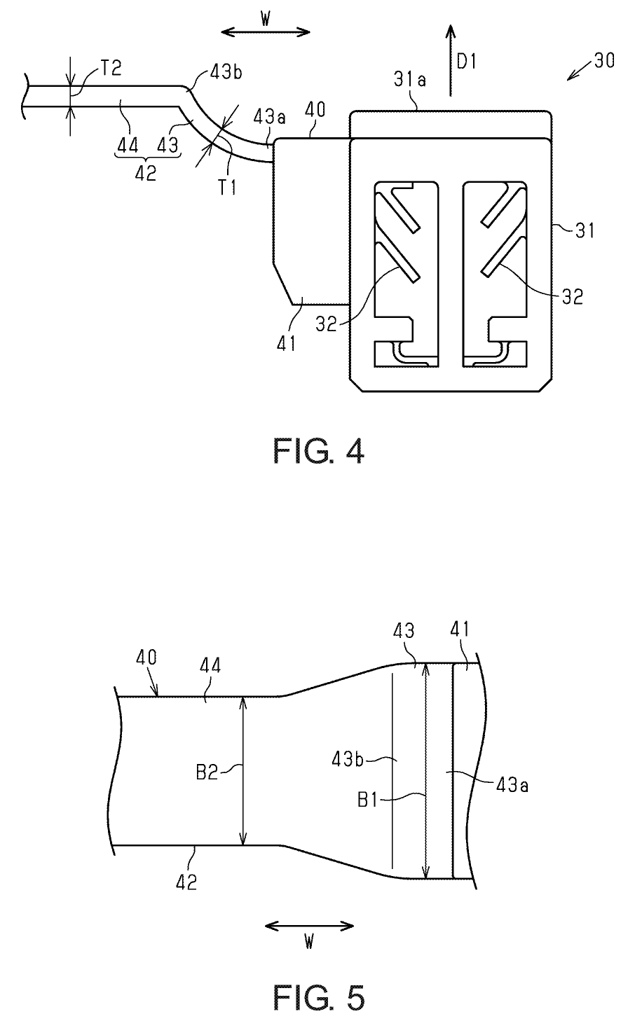

FIG. 4 is a partial front view showing a portion of the wire fixing member 30 alone, not holding the wire member 20. As shown in FIG. 4, the elastic biasing portion 43 of the band portion 42 of the wire fixing member 30 includes a first end portion 43a connected to the lock portion 41 and a second end portion 43b on the opposite side to the first end portion 43a. The elastic biasing portion 43 extends from the first end portion 43a to the second end portion 43b while being curved upward (in the attachment direction D1) up to the second end portion 43b. That is, in a state where the wire member 20 is not attached to the wire holding portion 40, the second end portion 43b is located on a downstream side of the first end portion 43a in the attachment direction D1. The band body 44 extends in the width direction W from the second end portion 43b of the elastic biasing portion 43. The thickness T1 of the elastic biasing portion 43 is set to be, for example, smaller than the thickness T2 of the band body 44.

FIG. 5 is a partial plan view showing the vicinity of the base end portion of the band portion 42 of the wire fixing member 30 shown in FIG. 4. As shown in FIG. 5, the band width B1 of the elastic biasing portion 43 provided at the base end portion of the band portion 42 is set to be greater than the band width B2 of the band body 44. Thus, even when a configuration is adopted in which the elastic biasing portion 43 is thinner than the band body 44 as described above, it is possible to easily ensure the strength of the elastic biasing portion 43 by increasing the band width B1 of the elastic biasing portion 43.

As shown in FIG. 3, the band portion 42 is configured such that, in a state prior to the fixing portion 31 being attached to the stud bolt 14, a portion of the band portion 42 wrapped around the wire member 20 is located on the downstream side of an upper end of the fixing portion 31 in the attachment direction D1. In the present embodiment, in the band portion 42 wrapped around the wire member 20, a region including the second end portion 43b of the elastic biasing portion 43 and the base end portion of the band body 44 connected to the second end portion 43b is located above the upper end surface 31a of the fixing portion 31 (i.e., located on the downstream side of the upper end surface 31a in the attachment direction D1). This region (the region including the second end portion 43b of the elastic biasing portion 43 and the base end portion of the band body 44) of the band portion 42 is configured as an abutment portion 45 that is pressed against the underfloor panel 13 in a state where the fixing portion 31 is attached to the stud bolt 14. In a state where the band portion 42 is wrapped around the wire member 20, the abutment portion 45 is configured to protrude toward the outer peripheral side while being separated from the wire member 20.

### Operation of Present Embodiment

The operation of the wire fixing member 30 will be described below.

After the wire member 20 is attached to the wire holding portion 40 by wrapping the band portion 42 around the wire member 20, the fixing portion 31 is fitted to the stud bolt 14 in the attachment direction D1 and attached. At this time, the abutment portion 45 of the band portion 42 abuts against the underfloor panel 13 in the attachment direction D1, and the elastic biasing portion 43 is deformed so as to bend. This deformation of the elastic biasing portion 43 generates an elastic force F1 that presses the abutment portion 45 of the band portion 42 against the underfloor panel 13. Therefore, a force greater than or equal to the elastic force F1 is required to separate the band portion 42, which is in contact with the underfloor panel 13, from the underfloor panel 13. This makes it easier to maintain a state where the band portion 42 holding the wire member 20 is in contact with the underfloor panel 13, and suppresses repeated contact of the band portion 42 with the underfloor panel 13 during vehicle vibration or the like.

### Effects of Present Embodiment

Next, effects of the present embodiment will be described.
(1) The band portion 42 of the wire fixing member 30 includes the elastic biasing portion 43 configured to generate an elastic force F1 that presses the band portion 42 against the underfloor panel 13 in a state where the fixing portion 31 is fixed to the underfloor panel 13. Thus, in a state where the wire fixing member 30 is attached to the underfloor panel 13, the band portion 42 holding the wire member 20 is pressed against the underfloor panel 13 by the elastic force F1 of the elastic biasing portion 43. Accordingly, vibration of the band portion 42 holding the wire member 20 can be suppressed during vehicle vibration, for example. As a result, generation of abnormal noise, damage to the band portion 42, or the like caused by repeated contact of the band portion 42 with the underfloor panel 13 can be suppressed. Furthermore, since the band portion 42 is pressed against by the elastic force F1 generated by the elastic biasing portion 43, the wire member 20 held by the band portion 42 can be made less likely to sag downward.

(2) The fixing portion 31 is attached to the stud bolt 14, which is provided on the underfloor panel 13, in the attachment direction D1 along the axis L1 thereof. The fixing portion 31 and the wire holding portion 40 are arranged side-by-side in the direction (the width direction W in the present embodiment) that is orthogonal to the attachment direction D1. This configuration allows the wire holding portion 40 including the band portion 42 to be placed closer to the underfloor panel 13, and therefore, the band portion 42 is easily pressed against the underfloor panel 13 by the elastic force F1 of the elastic biasing portion 43. As a result, vibration of the band portion 42 holding the wire member 20 can be more suitably suppressed.

(3) The band portion 42 is configured such that, in a state where the band portion 42 holds the wire member 20 and the fixing portion 31 is not yet attached to the stud bolt 14, a portion (the abutment portion 45 in the present embodiment) of the band portion 42 is located on the downstream side of the fixing portion 31 in the attachment direction D1. This configuration allows the band portion 42 to be placed closer to the underfloor panel 13, and therefore, the band portion 42 is easily pressed against the underfloor panel 13 by the elastic force F1 of the elastic biasing portion 43.

(4) The elastic biasing portion 43 is provided at the base end portion of the band portion 42 that is connected to the lock portion 41. In addition, the elastic biasing portion 43 is curved so as to be recessed toward the inner peripheral side in a state where the band portion 42 is wrapped around the wire member 20. This enables the elastic biasing portion 43 to have a shape that facilitates pressing of the band portion 42 against the underfloor panel 13.

(5) The thickness T1 of the elastic biasing portion 43 is set to be, for example, smaller than the thickness T2 of the band body 44. This can facilitate deformation of the elastic biasing portion 43 when pressing the band portion 42 against the underfloor panel 13. As a result, the band portion 42 can be suitably pressed against the underfloor panel 13 by the elastic biasing portion 43.

### Other Embodiments

The above embodiment may be implemented with the following modifications. The above embodiment and the following modification examples can be implemented in combination with each other as long as there is no technical contradiction.

In the wire fixing member 30, the structure for fixing the fixing portion 31 to the underfloor panel 13 is not limited to that of the above embodiment, and may be modified as appropriate according to the configuration of the wire harness 10. For example, a structure may be adopted in which the fixing portion of the wire fixing member 30 is fixed by being inserted into a through hole formed in the underfloor panel 13.

The shape of the underfloor panel 13 serving as the fixing target is not limited to a planar shape and may, for example, have a curved or bent shape at a location where the stud bolt 14 is not provided. In this case, the band portion 42 of the wire fixing member 30 may face a portion of the underfloor panel 13 in the width direction W.

In the wire fixing member 30, the wire holding portion 40 and the fixing portion 31 may be arranged side-by-side in the attachment direction D1. In this case, the band portion 42 may be configured to be pressed against a portion of the underfloor panel 13 facing the band portion 42 in the width direction W by the elastic force of the elastic biasing portion 43.

In the wire fixing member 30 of the above embodiment, the elastic biasing portion 43 is provided at the base end portion of the band portion 42 that is connected to the lock portion 41; however, the elastic biasing portion 43 may alternatively be provided at, for example, an intermediate portion in a length direction of the band portion 42.

In the wire fixing member 30, the thickness T1 of the elastic biasing portion 43 may be set to be equal to the thickness T2 of the band body 44 or greater than thickness T2 of the band body 44.

In the wire fixing member 30, a configuration may be adopted in which the fixing portion 31 and the wire holding portion 40 are formed as separate parts, and the lock portion 41 of the wire holding portion 40 is attached to the fixing portion 31.

In the above embodiment, the wire fixing member 30 is made of a synthetic resin; however, the present disclosure is not limited to this, and the wire fixing member 30 may be made of a metal material, for example.

In the wire member 20 of the above embodiment, the exterior material 22 may be an exterior material other than a corrugated tube.

In the above embodiment, the wire(s) 21 included in the wire member 20 may be a low-voltage wire.

In the above embodiment, the fixing target to which the wire fixing member 30 is fixed is the underfloor panel 13; however, the present disclosure is not limited to this, and any other fixing target may be employed. It should be noted that the configuration of the fixing portion 31 of the wire fixing member 30 may be changed according to the fixing target.

The embodiments disclosed herein are illustrative in all respects, and the present disclosure is not limited to these examples. That is, the scope of the present disclosure is indicated by the claims, and is intended to include all modifications that come within the meaning and scope of equivalency of the claims.

What is claimed is:

1. A wire fixing member comprising:
a fixing portion that is configured to be fixed to a fixing target; and
a wire holding portion that is configured to hold a wire, the wire holding portion including:
a lock integrally formed with the fixing portion; and
a band extending from the lock and being configured to hold the wire by wrapping around an outer periphery of the wire, the band having a leading end thereof inserted into and locked with the lock,
wherein the band includes an elastic biasing portion that is configured to generate an elastic force that presses the band holding the wire against the fixing target in a state where the fixing portion is fixed to the fixing target.

2. The wire fixing member according to claim 1, wherein:
the fixing portion is configured to be attached to a columnar attachment provided on the fixing target in an attachment direction along an axis of the columnar attachment, and
the fixing portion and the wire holding portion are arranged side-by-side in a direction that is orthogonal to the attachment direction.

3. The wire fixing member according to claim 2,
wherein the band is configured such that, in a state where the band holds the wire and the fixing portion is not yet attached to the columnar attachment, a portion of the band is located on a downstream side of the fixing portion in the attachment direction.

4. The wire fixing member according to claim 1, wherein:
the elastic biasing portion is provided at a base end of the band that is connected to the lock, and
the elastic biasing portion is curved so as to be recessed toward an inner peripheral side in a state where the band is wrapped around the wire.

5. A wire harness comprising:
the wire fixing member according to claim 1; and
the wire.
